(19) United States
(12) Patent Application Publication
(10) Pub. No.: US 2005/0087977 A1
(43) Pub. Date: Apr. 28, 2005

(54) Composite form assembly with frangible bonded layers formed in-situ

(76) Inventor: Jesse D. Crum, Fort Scott, KS (US)

Correspondence Address: WARD KRAFT, INC., P.O. BOX 938, FORT SCOTT, KS, 66701, US

(21) Appl. No.: 10/691,264

(22) Filed: Oct. 22, 2003

(51) Int. Cl. B42D 15/00

(52) U.S. Cl. 283/62

(57) ABSTRACT

The present invention relates to a non-impact printable, laminated form construction in which two or more layers are bonded together in-situ through use of a curable compound that creates a frangible bond between the layers which upon application of sufficient peeling pressure the form components or portions will separate from the composite form assembly. The in-situ bond formation occurs by passing select treatment energy through one or more layers of the laminate in order to cure the coating and thus secure the sheets or webs together. The present invention finds uses in a number of fields where it is generally desirable to create a tag, plate or other indicia containing device that is free of adhesive.

### CROSS-REFERENCES TO RELATED APPLICATIONS

None.

### FIELD OF THE INVENTION

The present invention relates to a non-impact printable, laminated form construction in which two or more layers are bonded together in-situ through use of a curable compound that creates a frangible bond between the layers which upon application of sufficient peeling pressure, select or predetermined portions of the form components will separate from the composite, laminated form assembly. The in-situ bond formation occurs by passing sufficient ultraviolet treatment energy through one or more layers of the laminate in order to cure the coating and thus secure the sheets or webs together to create the laminated assembly. The present invention finds uses in a number of fields where it is generally desirable to create a tag, plate or other indicia containing device that is free of adhesive, such as with apparel and textile tags, ski or lift tickets, event passes and the like. The present invention can be completed in its final configuration without any further processing steps such as folding or sealing.

### BACKGROUND OF THE INVENTION

Various products are available on the market today that enable the ready printing of separable components from a laminated or multiple part assembly. These include labels, dry release tags, self laminating products, self-adhesive products and the like. However, many of the products suffer from one or more drawbacks particularly when used in certain identification applications. These individualized or special applications makes use of such prior art assemblies cumbersome, difficult or contributes to having to undertake additional steps or procedures in order to effectively use the tag or label assembly in the prior art configurations.

Labels are well known in various industries for their use and application in identifying goods. Label or pressure sensitive adhesive assemblies, as they are generally known, are typically readily available and can be provided in a number of suitable formats or arrangements. However, labels are not suitable for all applications particularly where any exposed adhesive is a concern. In those instances when the adhesive may be exposed, the adhesive can come into contact with other surfaces to which the label or adhesive was not intended to adhere, touch or bond. In addition, even in those situations where adhesive contact is expected, the labels may leave behind adhesive residue on the initial surface to which the label was applied leaving the customer with an unwanted tacky substance which may mar, distort or otherwise take away from the appearance of the item from which the label has been removed. For example, where labels are applied to apparel items, fibers from the apparel can block the adhesive thus preventing the label from adhering to the surface of the apparel or textile product if the label needs to be removed and reapplied. In addition, the label can leave a “gummy” residue on the textile product, which if a consumer intends to wear the product, the residue first needs to be carefully removed. If care is not taken in removing the residue, such as through the use of a solvent or adhesive remover, the solvent can fade or discolor the textile or apparel item. In addition, if the exposed adhesive of the label catches another portion of the garment or article to which it is attached, the label may remain hidden from view thereby defeating the purposes of applying the identification piece.

Self-laminating products may overcome some of the drawbacks encountered with the use of labels, but require additional handling in order to complete the construction of the identification piece of the subject being identified. For example, a self-laminating card typically requires the user to align the component parts of the assembly (usually by folding over one portion on to the other) in order to finish affixing the assembly prior to use. If the alignment is not completely accurate, then there may be adhesive exposed in the assembly, leading to the problems identified above of unwanted adhesive contact. In addition, improper alignment may take away from other aspects of the assembly or the merchandise to which it has been applied. Moreover, such self laminating assemblies require the additional user interface (folding, alignment, etc.), to form or create the self laminating arrangement, thus requiring additional labor which proportionately increases the cost of application this ultimately is likely passed along to the consumer.

Another product offering that is available to textile and apparel manufactures are tags which are typically produced and provided in bulk to the manufacturer. Tags can be provided in a number of pre-determined sizes, styles and finishes and are usually constructed of a card or tag stock that is significantly more rigid than for instance bond paper. The tags can be over coated with a protective coating or may simply provide an exposed surface to which labels or other information may be added. In addition, the tags may be preprinted with indicia but typically do not lend themselves to automated personalization processes, in that the tags are typically not provided in a standard sheet format and may only come in, for example, one inch by two inch sizes or other configurations that are not readily adaptable to processing through a laser or ink jet printer. Thus, a retail outlet receives a number of tags in a container, such as a box or bag filled with non-personalized information, and then the retail establishment must have an employee hand write any additional information on the tag that is related to the garment or article, such as price, size, quantity or the like. Alternatively, the retailer can affix a supplemental label over the tag so that the label rides “piggyback” on the tag. However, this requires the additional steps of printing and applying the additional label as well as the cost of the supplemental structure. While the use of tags overcomes some of the problems with labels, of not having any exposed adhesive or leaving behind adhesive residue they still suffer from additional drawbacks in that they require supplemental labor involvement in order to complete the tag.

Frangible adhesive bonds are generally known and provide a temporary bond or holding arrangement and have been used in forming a laminated product. Once the bond is broken, the bond cannot be reformed unless there is remaining tacky adhesive which then may enable the assembly to be re-laminated. However, this defeats the purposes of the so called “dry technology” as the exposed surfaces, revealed upon separation from the assembly, are not completely dry and instead have a wet area. Such a situation is generally undesirable in connection with the apparel and textile industry as any wet chemicals, adhesives, or the like can soil or stain the textile or apparel piece.

The use of “dry technology” or so called dry tags, has been developed and typically includes the use of an adhesive coating that is applied to the back of a layer or sheet and is then treated so that the coating will bond to the layer or to a carrier assembly. Then upon the application of sufficient force to the layer that the user desires to remove, in theory, the layer is supposed to release cleanly from the laminate without adhesive residue being present, visibly or otherwise, as the adhesive is supposed to have dried.

However, such products unfortunately still can suffer from a number of drawbacks and disadvantages in that if the bond between the layers of the material is to aggressive or strong then upon separation, for example through peeling or delaminating force, the portions or components of the form will tear or rip apart thereby destroying the functionality of the form construction. That is, the portions will suffer from “fiber tear” where a portion (usually the face or back) of one layer detaches or delaminates and remains with the other layer thus creating the appearance of ripping or a defective tag.

This creates an undesirable effect, in that it makes the removed layer appear as if it had been tampered with because of the appearance of the torn fiber. Moreover, the layer may no longer be readily adaptable to receiving additional information due to the surface deformations. In addition, where hang tags are being produced in the assembly, or other assemblies where die cut portions or removable portions are to remain with the supporting laminate, the hole or other die cut portion from which the tag is to be supported usually does not separate from the tag once the tag is removed. When this occurs, this will likely require the user to have to poke out the hole or remove the die cut portion in order to utilize the tag. Too much force can damage the tag leading to waste, not to mention frustration of the user as the tag can be destroyed or otherwise distorted in appearance.

The creation of dry technology products can also be expensive in that manufacturing process for this type of technology has heretofore typically required a plurality of steps in order to create a sufficient seal that will bind the two layers together. In such manufacturing processes, a sheet or web of material is coated with a layer of a curable coating, typically an adhesive coating. The coating, which is exposed, is then subjected to a direct curing treatment and shortly thereafter, a second sheet or web is applied over the first sheet or web creating a sandwich or laminate and thus covering the coating layer.

The difficulty with this process is that once the curing energy has been applied directly to the coating layer, there is only a finite amount of time in which to apply the second sheet or web. If the second sheet or web is applied prematurely, the coating will not properly cure and the sheets will not be adequately laminated together and hence the sheets may splay or shift out of alignment with one another, which is referred to as a “loose” arrangement. This loose arrangement can subsequently cause printer jams and jamming of other processing equipment as the edges of one or more sheets can catch on the edges of the equipment.

Over curing of the exposed coating material can also occur and may result in a “tight” arrangement in which the sheets when pulled apart will suffer from fiber tear that is a portion of one sheet will be torn off and left behind on the other sheet, generally making the sheets unusable.

If one waits too long to apply the second sheet or web, the coating can then dry out and the formation of a bond between the two sheets is likely impossible. Thus, if the process and timing are not closely monitored, the sheets, webs and coatings can be wasted not to mention the time the operator spent in preparing the product.

In a second prior art process for making dry technology products, a first sheet or web is coated with a silicone layer to which a cold or other curable glue is then applied and remains exposed for subsequent treatment. The curable adhesive is then treated and a second sheet or web is applied over the glue to create a laminate. Once the glue is fully cured, then the sheets may be separated as the adhesive is supposed to be dry and hence cannot contaminate surrounding areas through unwanted adhesive contact. However, this process in addition to the difficulties enumerated above with respect to careful control of the timing of the curing and placement of the webs also suffers from the drawback in that it requires additional materials, such as a silicone coated first liner and as such can be more costly to produce.

A still further dry technology type arrangement is provided in U.S. Pat. No. 6,569,280 in which a card is placed into a portion of a business form, and a patch with an adhesive coating is applied to hold the card in position. The adhesive coating is then treated with electromagnetic radiation through the card or patch to cure the adhesive. However, the card and patch need to be water vapor impermeable in order for the sealing arrangement to work. With business forms, it is very difficult to maintain constant conditions for the business form from manufacture, during shipment and handling to use by the end user. As such, an arrangement would not lend itself to multiple applications, particularly as they relate to apparel or textile uses. In addition, the foregoing arrangement is a relatively complex assembly requiring a business form, card, patch and coating to be applied in a particular sequence. Once formed, the assembly must still undergo further steps such as folding and sealing in order for the assembly to be delivered to the intended recipient. In addition, such a construction would also likely not be printable in a non-impact printer due to the difficulties associated with the “hump” or bump created by the raised area of the card/patch.

Publications, patents and patent applications are referred to throughout this disclosure. All references cited herein are hereby incorporated by reference.

What is needed therefor is a simple, composite form assembly that permits the ready printing of both static and variable information as well as one that enables the easy separation of form components from the assembly and without further handling and which overcomes the drawbacks referenced above by enabling the laminate to be formed in situ through the use of passing the curing energy directly through one of the sheets or webs in the laminated construction.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

In one embodiment of the present invention composite form assembly is described and includes a first layer having first and second surfaces, at least one of the first and second surfaces capable of receiving printing. The first layer has a series of die cuts that divide the first layer into a number of removable elements, with each of the removable elements having a major portion and a minor portion with the minor portion remaining with a second layer of the form assembly upon removal of the major portion. The second layer is also provided and has first and second surfaces and is made of a different material than the first layer. The presently described embodiment also includes a coating that is disposed between the first and second layers, in the area covered by the removable elements wherein upon application of ultraviolet or other treatment energy which passes through one of the first and second layers, the coating forms a frangible bond between the first and second layers.

In a still further embodiment of the present invention, a method of communicating the use of a dry technology apparel or textile tag product is described and includes the steps of initially preparing at least one sheet having a plurality of removable items, each of the removable items has a major portion and a minor portion that forms the tag. The sheet from which the tags are die cut can receive both preprinted and variable indicia. Next, marketing collateral relating to the use and removal of the major portion of the tag from the sheet is produced, which emphasizes that the minor portion of the tag remains with said sheet. The promotional and marketing collateral or material is then used with the advertising of the dry technology apparel or textile tag product. The dry technology apparel or textile tag product is sold and finally, the dry technology apparel or textile tag product is distributed to a purchaser or end user.

In a yet still further embodiment of the present invention, a peelable laminate having a frangible bond, is described and includes a first layer that has a first thickness and first and second surfaces and has a series of die cuts formed therein to create a number of removable elements. At least one of the first and second surfaces can be printed or imaged. The construction is also provided with a second layer that has a second thickness different than the first thickness. A coating composition is used to secure the first and second layers one to another upon application of a treatment to form a seal. The treatment, such as the application of ultraviolet energy, passes through one of the first and second layers to create the seal.

The first layer of this presently described embodiment has a series of die cuts provided therein, with the die cuts producing separable removable elements such as tags and pin holes. Each of the tags has a major portion and a minor portion, with the major portion having a surface area at least ten times greater than a surface area of the minor portion. Upon removal of the major portion from the first layer, the tag portion, the minor portion, or pin hole remains adhered to the first layer and does not require the user to have to subsequently push or poke out the pin hole or minor portion in order to utilize the tag of the present invention.

In a yet still further embodiment of the present invention an in-situ cured laminated business form is described and includes a first layer of material having first and second faces and a second layer of material having first and second faces. A curable coating is applied to one of the first and second faces of each of the first and second layers. The curable coating is cured in-situ by treatment energy that is passed through one of the first and second layers to form a laminated, adhesive free business form having at least one removable element.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts generally one face sheet or layer of the present invention in which a number of removable elements are shown;

FIG. 2 illustrates the face sheet or layer of the present invention as provided in FIG. 1, with one of the removable elements removed from the face sheet or layer and exposing the remnants of the coating;

FIG. 3 shows a cross section of the laminate of the present invention and the in-situ formed bond between the face sheet or layer and the back sheet or layer;

FIG. 4 provides a further embodiment of the present invention showing a foldable pair of removable elements; and

FIG. 5 presents an exemplary use of the present invention after a removable element has been removed from the face sheet of the laminated construction, and is hung or attached to an article.

### DETAILED DESCRIPTION OF THE INVENTION

The present invention is now illustrated in greater detail by way of the following detailed description, but it should be understood that the present invention is not to be construed as being limited thereto.

Unexpectedly, it has been discovered, that “dry technology” business forms can be created in-situ in a straight forward and simple process through the use of a curable coating compound, heretofore previously unconsidered for this application, that enables treatment energy, such as ultraviolet energy (“UV”) to be passed directly through one or more of the layers that make up the business form assembly and creates the final laminated arrangement in a non-impact printable sheet. In addition, and surprisingly it has been found that the strength of the curing compound can also be manipulated through the type and intensity of the energy that is permitted to be passed through the one or more layers, sheets or webs of the business form assembly. The present assembly is created when it is in a final configuration and does not require the supplemental steps of folding or sealing in order to further process the product prior to distribution to an end user or recipient.

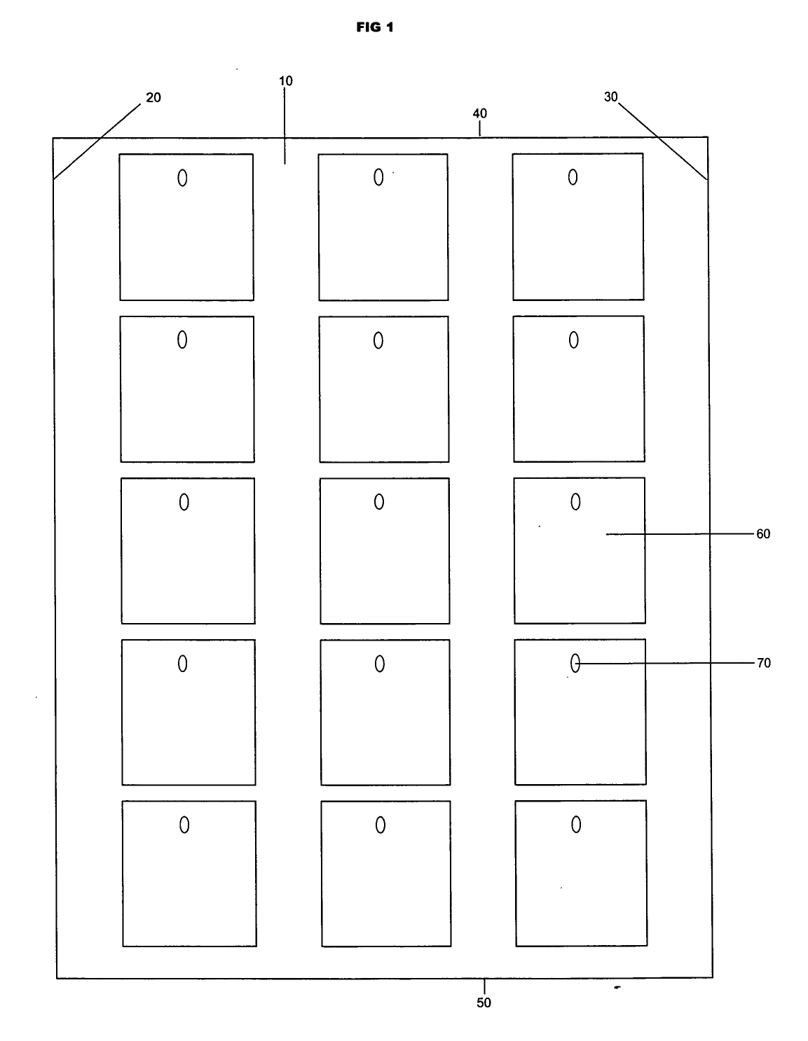

Turning now to FIG. 1 of the instant specification, the present invention has a face sheet or top layer 10 that is selected from suitable stock material. Such suitable material includes generally cellulosic based material up to a 16 point board or tag stock with 100 pound tag stock also being used for certain applications, and about a 70-80 pound tag being preferred for lighter applications (125 pound stock is equal to 10 point stock). However, the stock material may also be derived from synthetic films such as polyethylene terephthalate (“PET”) or other plastic like materials. The first layer or sheet 10 includes first and second longitudinally extending sides edges 20 and 30 and first and second transversely extending end edges 40 and 50. The face sheet 10 is provided with any number of removable elements that contain a major portion 60 and a minor portion 70. Each of the removable elements are created through the use of die cuts, laser scoring, or any general scoring, cutting or perforating that may be acceptable in achieving the present objects of the invention. As provided in FIG. 1, a series of removable elements, here tags, are arranged in rows or columns.

The depiction of the removable elements as provided in FIG. 1 are hang tags or apparel tags, wherein the major portion includes the tag section and the minor portion is the pin hole or hole through which string, wire, or other means are inserted in order to enable the hanging or support of the tag from an item. The intention of the tag is for identification, pricing, inventory, information or any other purposes to which tags are generally made and used.

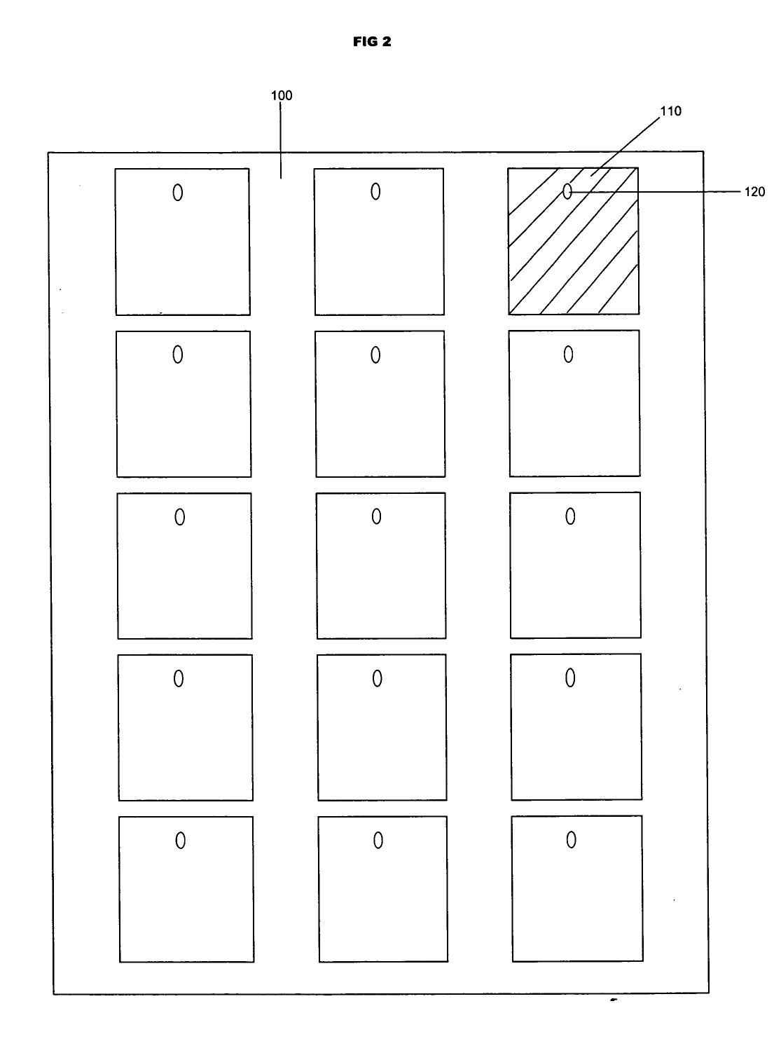

Turning now to FIG. 2, the first face or front face is again depicted and this time is referenced by numeral 100. The first face 100 again shows a number of removable elements however in FIG. 2 one of the elements has been removed by application of a peeling force. Such a peeling force may be applied by slightly bending the form and lifting the removable element, such as with ones fingers or through the use of a mechanical appliance, i.e. tweezers or pliers, the use of an exposed edge such that the frangible coating may be broken when the tag is pulled away. The coating will substantially remain with the carrier or release ply to be described herein. Some of the coating may remain with the removable element, but it will generally be unnoticeable.

The remnants of the frangible coating are shown by reference to numeral 110 (formerly occupied by the major portion of the removable element) showing only minor portion 120 remaining attached to the form assembly. While not wishing to be bound to any particular theory the surface area of the major portion of the removable element applies sufficient frangible seal breaking strength so as to enable the separation of the major portion from the form assembly. The minor portion 120 having been die cut from the major portion, does not have sufficient peeling strength applied to its structure and as such remains with the assembly after removal of the major portion. In this exemplary embodiment, the major portion has up to ten times the surface area of the minor portion to enable the clean separation and removal from the assembly, but a ratio of as little as 3 to 1 and preferably 4 to 5 to 1 will also operate effectively.

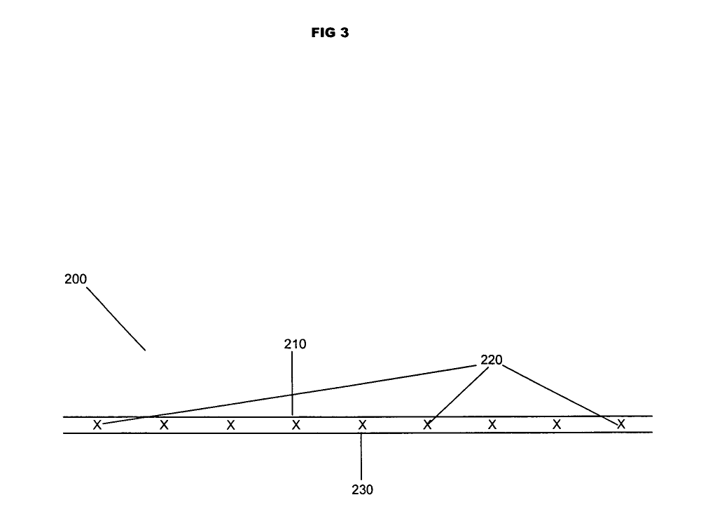

FIG. 3, provides a cross sectional view of the present invention generally designated by reference to numeral 200 and includes a first layer or first sheet 210 and a second layer or second sheet 230. The curable coating 230 of the present invention is disposed between the first 210 and second 230 sheet of the laminated business form construction.

The second sheet or second layer 230 of the present invention can range from a transparent to translucent to a semi opaque sheet of material that may be derived from cellulosic materials such as paper, glassine, wax paper, and the like to synthetic materials that will enable the treatment energy to pass through the layer so as to be able to cure the coating in-situ. The thickness of the second layer or sheet 230 can range from about 1 mil up to about 7 mils and more preferably between about 2 mils to about 3 mils with about 2.2 mils to about 2.5 mils being preferred. One exemplary sheet suitable for use in the present invention that enables sufficient energy to pass through is UV230 from Nicolet Paper of Depere, Wis. Another exemplary layer is a machine finished 400MF available from Wassau Paper of Wassua, Wis. However, standard 20 pound bond paper may also be used and is suitable for passing sufficient energy through to enable the curing of the UV curable coating through the paper.

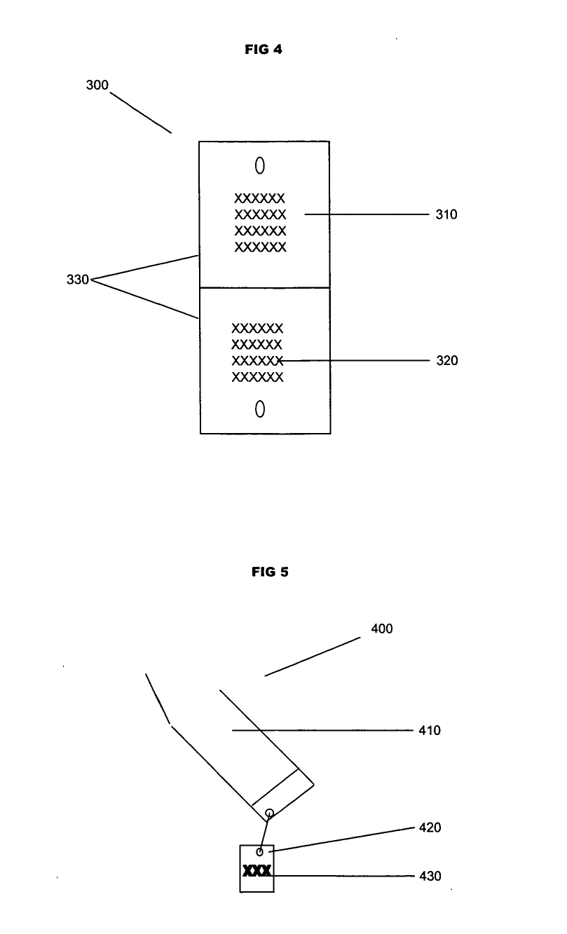

Turning now to FIG. 4, an alternate embodiment of the present invention is generally depicted by reference to numeral 300 and includes first and second panels 330, each of which may be provided with printing 310 and 320. The tag of FIG. 4 may be folded about a central fold line so as to create a mating arrangement of tags that cooperate to form a double sided tag structure. That is, relatively equal portions of the tag are brought into alignment with one another. Such a structure may find uses in a number of areas such as ski or lift tickets, entry or admission passes or tickets, press credentials, identification tags, fish and game licenses, post cards, baggage tags as well as the apparel or textile tags as described herein.

FIG. 5, provides an exemplary use of the present invention and is generally depicted by reference to numeral 400. An apparel item 410, such as a sleeve, is identified through the use of the tag 420 created in accordance with the present invention. The tag 420 has indicia provided on the label, pricing, size, use and care instructions, etc. to enable the retailer and potential customer to identify the article prior to use.

An exemplary coating of the present invention is a UV curable coating distributed under the product name FT30LI and is available from Northwest Coatings Corp., Oak Creek, Wis. 53154 and is composed of various acrylate monomers and oligomers. The coating maintains a boiling point of greater than 200° C., a vapor density of greater than 1 (air=1), an evaporation rate of greater than 1 (n-Butyle Acetate=1) and a vapor pressure of less than 1 (MM HG at 25° C.).

The production of the present invention is relatively straight forward and includes the provision of a first sheet of material, such as a translucent sheet of glassine or machine glazed or machine finished paper having a thickness ranging form about 1 mil to about 3 mils. The UV curable coating is applied to the first sheet in a thickness ranging from about 0.001 mils to 3 mils with about 0.01 to 1 mils being preferred. Next, a top sheet is placed in registry and alignment with the bottom sheet so as to create an intermediate laminate, in which the sheets have not yet been bonded together.

The top sheet as provided above can range from about 16 point stock (board or tag stock) to 20 pound bond paper (125 pound stock is equal to 100 point stock for a point of reference). As such, depending on the construction being prepared, the top sheet can be selected predetermined performance characteristics.

The coating may be applied throughout the entire area of one of the first and second sheets or only one of the sheets so as to create an entire coated sheet or a substantially coated sheet or the coating may only appear in the area of the die cuts that form the removable tags or other elements. The die cuts or stampings are typically only applied to the top sheet or layer as the bottom sheet or layer forms a carrier layer which will remain with the matrix of the top sheet once the removable elements have been removed. That is, once the major portion, the tag, has been removed, the dot, the minor portion, that is to form the hole for insertion of the string, wire, etc. to hold the tag to the article (see FIG. 5) remains with the carrier sheet, as well as any surrounding areas not intended to be detached with the tag.

Once the intermediate laminate has been created the intermediate assembly is then forwarded to a curing station where at least one if not additional UV curing stations which contain UV bulbs that are provided for curing purposes. The curing stations may use “H” bulbs described below and/or the Gallium bulb, which is also described below.

In practicing an exemplary embodiment of the present invention, a series of UV curing bulbs, which can be positioned in a side by side, adjacent or sequential configuration can be used. In an exemplary embodiment, a single bulb may allow a UV cure rate of approximate 50 feet per minute, while plural bulbs disposed in a side-by-side or adjacent configuration, permits a higher curing rate of approximately 75 feet per minute. Obviously, other curing station configurations may be used in order to increase the possible through put rate of the equipment and processing of the substrates to be printed.

Exemplary bulbs used in the embodiment of the present invention are “H” bulbs and Gallium doped bulb suitable for use in the UV curing processes, however, it should be understood that other UV curing may be used in accordance with the present invention and the present invention is not limited hereto.

The “H” bulb is generally known as a mercury vapor bulb and is used typically for top surface curing applications. The Gallium doped bulb is used in connection with a requirement for deeper penetration such as within a slurry. The UV bulbs such as those described above along with reflectors, to focus or concentrate the energy, are available from the GEW Company, located in North Royalton, Ohio. Alternatively, a combination of both topical and penetration curing can result in a combination of curing energies sufficient to carry out the present invention.

The sheets or layers of the present do not need to be water vapor impermeable and may be selected from any suitable stock to which the coating may be applied and die cuts may be rendered or produced to create at least one if not an entire series of removable elements.

The structure of the laminated assembly of the present invention is generally if not substantially planar, that is there are no bumps or ridges such as with a protruding card or label which would interfere with the processing of the laminated assembly through a non-impact printer, such as a laser printer or ink jet printer.

One of the most important things with respect to new product innovations is the need to effectively market and communicate the new product to potential customers and end users of the product. Such marketing typically includes the creation of marketing collateral associated with the features of the laminated, dry technology assembly and then selling the assembly in connection with that marketing collateral and then distributing the laminated, dry technology assembly to potential end users and customers. Customers can include distributors of such products as well as office supply stores, retail and warehouse outlets that may not be end users, but may repackage and resell the products to end users or third parties.

Marketing collateral as used herein includes the use of scripted or prepared material that are distributed through audio and visual communication mediums, over a global communication network, through printed mediums such as newspapers, trade publications, magazines, fliers, handouts and the like.

It will thus be seen according to the present invention a highly advantageous dry technology tag for use in connection with apparel or textile product has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A composite form assembly, comprising;
a first layer having first and second surfaces, at least one of said first and second surfaces capable of receiving printing, said first layer having a series of die cuts that divide said first layer into a number of removable elements, with each of said removable elements having a major portion and a minor portion with said minor portion remaining with a second layer on removal of said major portion;
said second layer having first and second surfaces and said second layer is composed of a different material than said first layer; and
a coating disposed between said first and second layers and provided in the area of at least said removable elements, wherein upon application of ultraviolet energy through one of said first and second coatings, said coating forms a frangible bond between said first and second layers.

2. A composite form assembly as recited in claim 1, wherein said major portion is used as an apparel, textile tag or combinations thereof.

3. A composite form assembly as recited in claim 1, wherein said minor portion is a die cut portion.

4. A composite form assembly as recited in claim 1, wherein the coating is applied substantially over one of said first and second layers.

5. A composite form assembly as recited in claim 1, wherein said energy applied to said composite form assembly is ultraviolet radiation and is applied through the use of a gallium bulb, H bulb or combinations thereof.

6. A composite form assembly as recited in claim 1, wherein said second layer has a thickness of not more than about 7 mils.

7. A method of communicating the use of a dry technology apparel or textile tag product, comprising the steps of;
initially preparing a laminated sheet having a plurality of removable items, each of said removable items having a major portion and a minor portion, said at least one sheet can receive both preprinted and variable indicia, said laminated sheet prepared from first and second sheets and a curable coating disposed there between and said curable coating is cured through one of said first and second sheets;
producing marketing collateral relating to removal of said major portion from said sheet while said minor portion remains with said sheet;
advertising said dry technology apparel or textile tag product in connection with said marketing collateral;
selling said dry technology apparel or textile tag product; and
distributing said dry technology apparel or textile tag product to a purchaser.

8. A method of communicating as recited in claim 7, wherein said major portion is an apparel or textile hang tag.

9. A method of communicating as recited in claim 7, wherein said major portion is used to create ski or lift tickets, entry or admission passes or tickets, press credentials, identification tags, fish and game licenses, post cards, baggage tags and combinations thereof.

10. A peelable laminate having a frangible bond, comprising;
a first layer having a first thickness and having first and second surfaces with at least one of said first and second surfaces receiving printing;
a second layer having a second thickness different than said first thickness and having first and second layers;
a coating composition securing said first and second layers one to another upon application of a treatment to form a seal, said treatment passing through one of said first and second layers to create said seal; and
said first layer having a series of die cuts provided therein, said die cuts producing separable tags with each of said tags having a major portion and a minor portion, with said major portion having a surface area at least ten times greater than a surface area of said minor portion and wherein upon removal of said major portion from said first layer, said minor portion remains adhered to said first layer.

11. A peelable laminate having a frangible bond as recited in claim 10, wherein said treatment is ultraviolet treatment.

12. A peelable laminate having a frangible bond as recited in claim 10, wherein said coating is applied to substantially all of one of said first and second faces of at least one of said first and second layers.

13. A peelable laminate having a frangible bond as recited in claim 10, wherein said peelable laminate is substantially planar.

14. A peelable laminate having a frangible bond as recited in claim 10, wherein said major portion is used to create apparel or textile tags, ski or lift tickets, entry or admission passes or tickets, press credentials, identification tags, fish and game licenses, post cards, baggage tags and combinations thereof.

15. A peelable laminate having a frangible bond as recited in claim 10, wherein said second layer has a thickness ranging from about 1 mil to about 3 mils.

16. A peelable laminate having a frangible bond as recited in claim 10, wherein said coating composition includes acrylated monomers and oligomers.

17. An in-situ cured laminated business form, comprising;
a first layer of material having first and second faces;
a second layer of material having first and second faces;
at least one of said first and second layers having a series of die cuts formed therein to create a plurality of removable elements; and
a curable coating applied to one of said first and second faces of each of said first and second layers corresponding to an area covered by said removable elements, said curable coating cured in-situ by treatment energy passed through one of said first and second layers to form a laminated, adhesive free business form having at least one removable element.

18. An in-situ cured laminated business form, as recited in claim 16, wherein said removable elements are used to create apparel or textile tags, ski or lift tickets, entry or admission passes or tickets, press credentials, identification tags, fish and game licenses, post cards, baggage tags and combinations thereof.

19. An in-situ cured laminated business form, as recited in claim 16, wherein said treatment energy is ultraviolet.

20. An in-situ cured laminated business form, as recited in claim 16, wherein said coating includes acrylated monomers and oligomers.
